(19) United States
(12) Patent Application Publication
(10) Pub. No.: US 2015/0012329 A1
(43) Pub. Date: Jan. 8, 2015

(54) PROCESS FLOW INFRASTRUCTURE AND CONFIGURATION INTERFACE

(71) Applicant: Microsoft Corporation, Redmond, WA (US)

(72) Inventors: Rashmi Prakash, Bellevue, WA (US); Sharad Bajaj, Redmond, WA (US); Omar Ayoub, Redmond, WA (US); Aniket Naravanekar, Renton, WA (US); Brandon Simons, Kirkland, WA (US); Wayne Higgins, Seattle, WA (US); Derik Stenerson, Redmond, WA (US); Michael McCormack, Snohomish, WA (US); Gautam Dharamshi, Redmond, WA (US); Sandhya Vankamamidi, Sammamish, WA (US)

(73) Assignee: Microsoft Corporation, Redmond, WA (US)

(21) Appl. No.: 13/933,465

(22) Filed: Jul. 2, 2013

(51) Int. Cl. G06Q 10/06

(52) U.S. Cl. CPC G06Q 10/06316
USPC 705/7.26

(57) ABSTRACT

A user interface display is generated with user input mechanisms to receive business process flow definition inputs from a user. The definition inputs can include identifying stages and steps within stages, for a plurality of different entities. When the user accesses the business process, a user interface display shows the stages that are involved in completing the business process, and guides the user through the steps that the user is to complete in performing the process. The process can involve multiple entities, and a single entity can involve multiple processes.

### BACKGROUND

Computer systems are currently in wide use. Many computer systems employ both data records and processes. This often means that a user must flip back and forth between different data records in order to complete a process, which can be cumbersome.

By way of example, some computer systems include business systems. Business systems can include such systems as enterprise resource planning (ERP) systems, customer relations management (CRM) systems, line-of-business (LOB) systems, among others. Such business systems often include data records and processes or workflows that operate on the data records. Business applications implement the processes and workflows and access the data records.

Data records can include, for instance, entities. Entities are data records that represent underlying items. For instance, an opportunity entity represents a business opportunity to the organization. A vendor entity represents a vendor, a product entity represents a product, a customer entity represents a customer, etc.

In order to perform a business process, a user may need to access multiple different entities. For instance, the process of identifying a business opportunity and then pursuing it to an ultimate sale and closing the opportunity as successful may involve the user accessing multiple different entities in the business system. In addition, a single entity may be involved in multiple different processes.

To date, the business processes have been entity-centric. Therefore, when a user is performing a business process within a business system, the user is provided with relatively little guidance that indicates where the user is in the overall process, and what the next steps or entities may be. Even though the business process may be relatively well defined, it can be quite complex, and the user is left without context or an overall roadmap to achieve the goal of the business process.

Some business systems provide dialogs which ask users a set of questions in every step of the process and filter future business steps based on the inputs to the dialog questions. However, these dialogs do not provide contextual information to the end user about an overall roadmap and progress, and an indication of progress within the business process. In addition, the dialogue experience has not been embedded in an entity record which the user is working on. Thus, the dialogs need to be started independently.

The discussion above is merely provided for general background information and is not intended to be used as an aid in determining the scope of the claimed subject matter.

### SUMMARY

A user interface display is generated with user input mechanisms to receive business process flow definition inputs from a user. The definition inputs can include identifying stages and steps within stages, for a plurality of different entities. When the user accesses the business process, a user interface display shows the stages that are involved in completing the business process, and guides the user through the steps that the user is to complete in performing the process. The process can involve multiple entities, and a single entity can involve multiple processes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram showing one embodiment of the operation of the business system in configuring a process.

FIGS. 2A-2J are illustrative user interface displays.

FIG. 3 is a flow diagram illustrating one embodiment of the operation of the business system shown in FIG. 1 in allowing a user to perform a business process.

FIGS. 3A-3F are illustrative user interface displays.

FIG. 4 is a block diagram of one embodiment of the business system shown in FIG. 1 in various architectures.

FIGS. 5-9 show various embodiments of mobile devices.

FIG. 10 is a block diagram of one illustrative computing environment.

### DETAILED DESCRIPTION

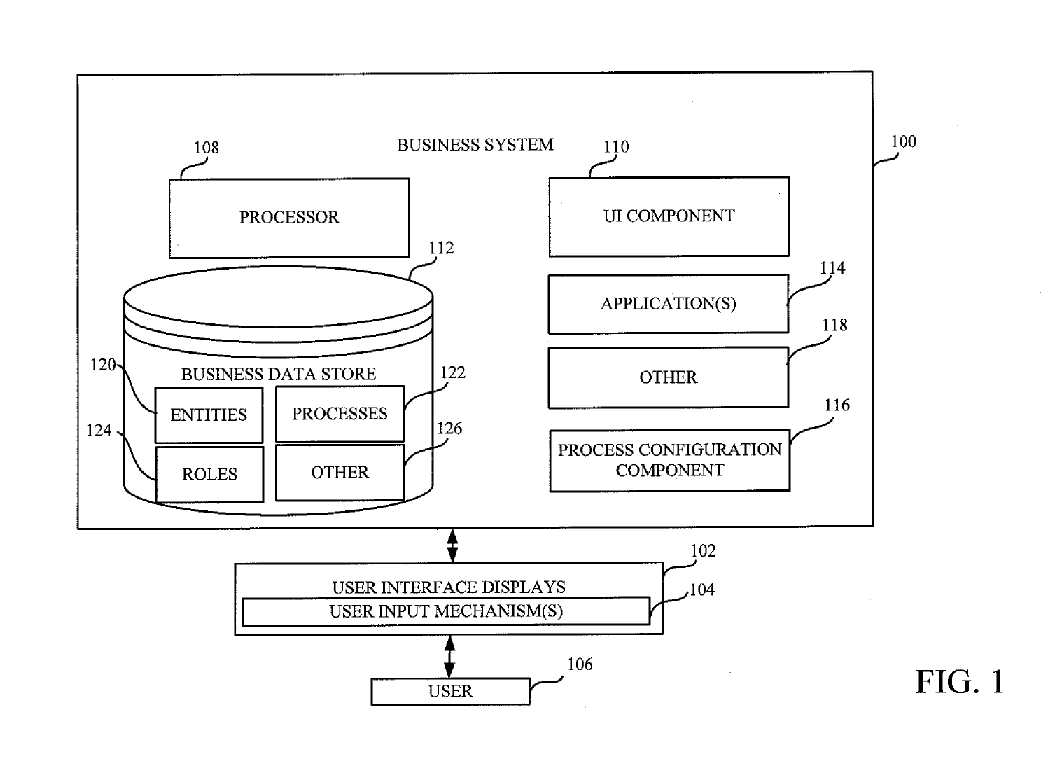

FIG. 1 is a block diagram of one illustrative business system 100. Business system 100 is shown generating user interface displays 102 with user input mechanisms 104 for interaction by user 106. Business system 100 illustratively includes processor 108, user interface component 110, business data store 112, applications 114, process configuration component 116, and other components 118. Business data store 112 is shown as storing entities 120, processes 122, roles 124 and other information 126.

Applications 114 can be a wide variety of different types of business applications that access entities 120, roles 124, processes 122 and other information 126 in business data store 112. The application can illustratively be controlled or accessed and manipulated by user 106 through user input mechanisms 104 and through interface displays 102. By way of example, applications 114 can include business opportunity applications that track business opportunities for the organization employing business system 100, general ledger applications that provide general ledger functionality, various other accounting applications, inventory tracking applications, etc.

Processor 108 is illustratively a computer processor with associated memory and timing circuitry (not separately shown). It is illustratively a functional part of system 100 and is activated by, and facilitates the functionality of, other components, applications, or other items of business system 100.

UI component 110 illustratively generates user interface displays 102 with user input mechanisms 104 for interaction by user 106. UI component 110 can generate the user interface displays 110 on its own, or under the control of another component or item in business system 100.

User input mechanisms 104 can take a wide variety of different forms. For instance, they can include text boxes, check boxes, buttons, icons, links, drop down menus, etc. In addition, they can be actuated by user 106 in a variety of different ways. For instance, they can be actuated using a point-and-click device (such as a mouse or track ball), by using a thumb pad, a keypad, a joystick, various buttons or other actuators, a hardware or soft keyboard, etc. In addition, where business system 100 (or the device on which user interface displays 102 are displayed) includes speech recognition components, they can be actuated using speech commands. Further, where the device on which user interface displays 102 are displayed is a touch sensitive screen, user input mechanisms 104 can be actuated using touch gestures.

Process configuration component 116 illustratively allows user 106 to configure processes 122 in business system 100. This is described in greater detail below with respect to the remaining FIGS.

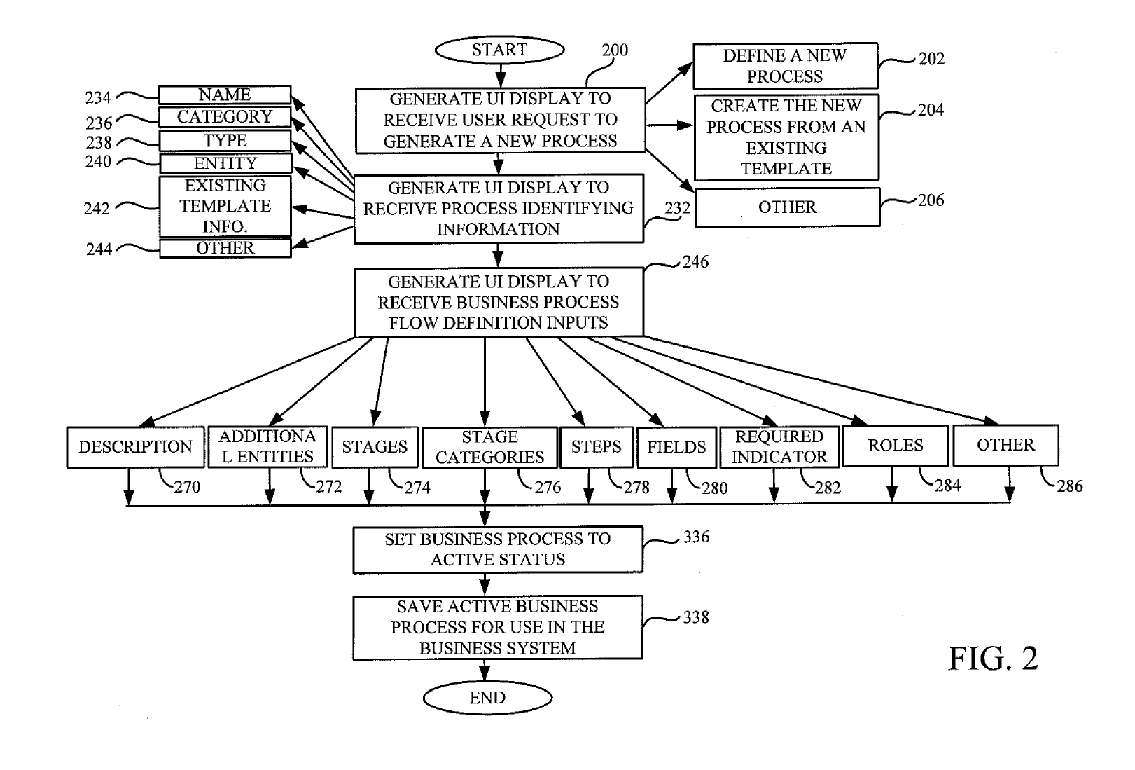

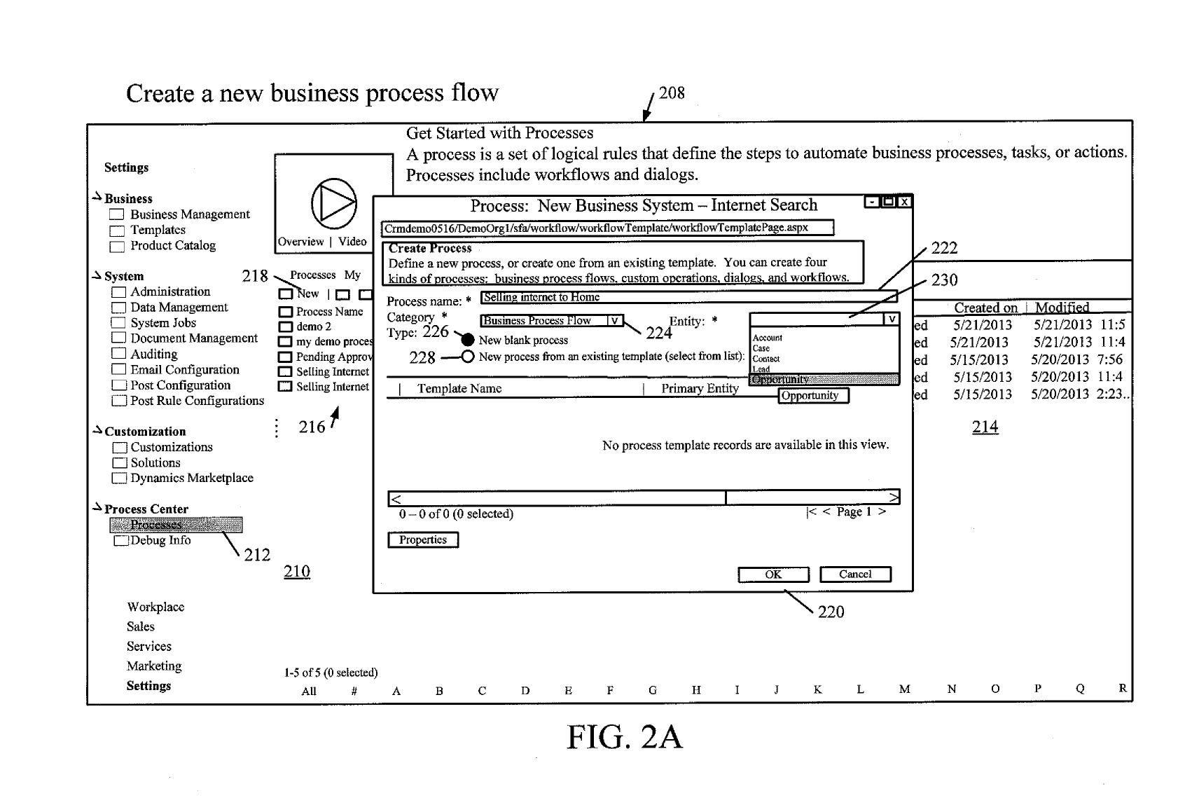

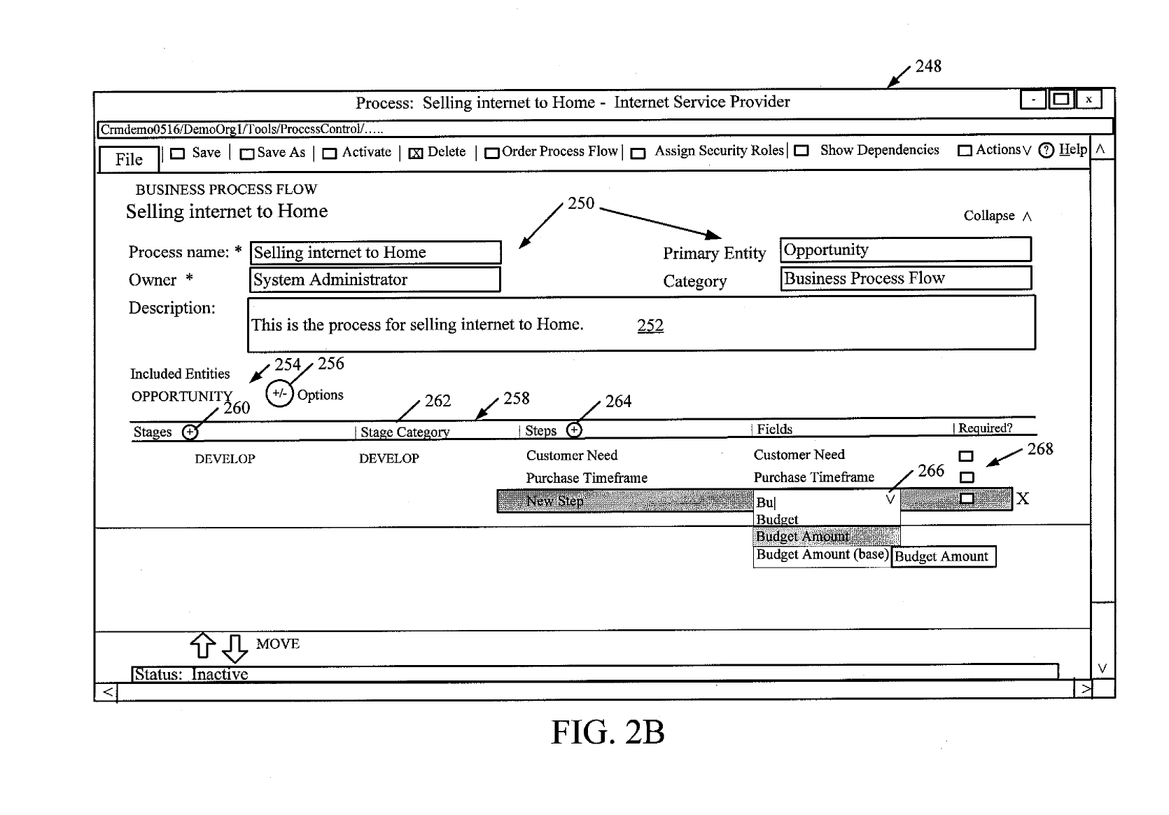

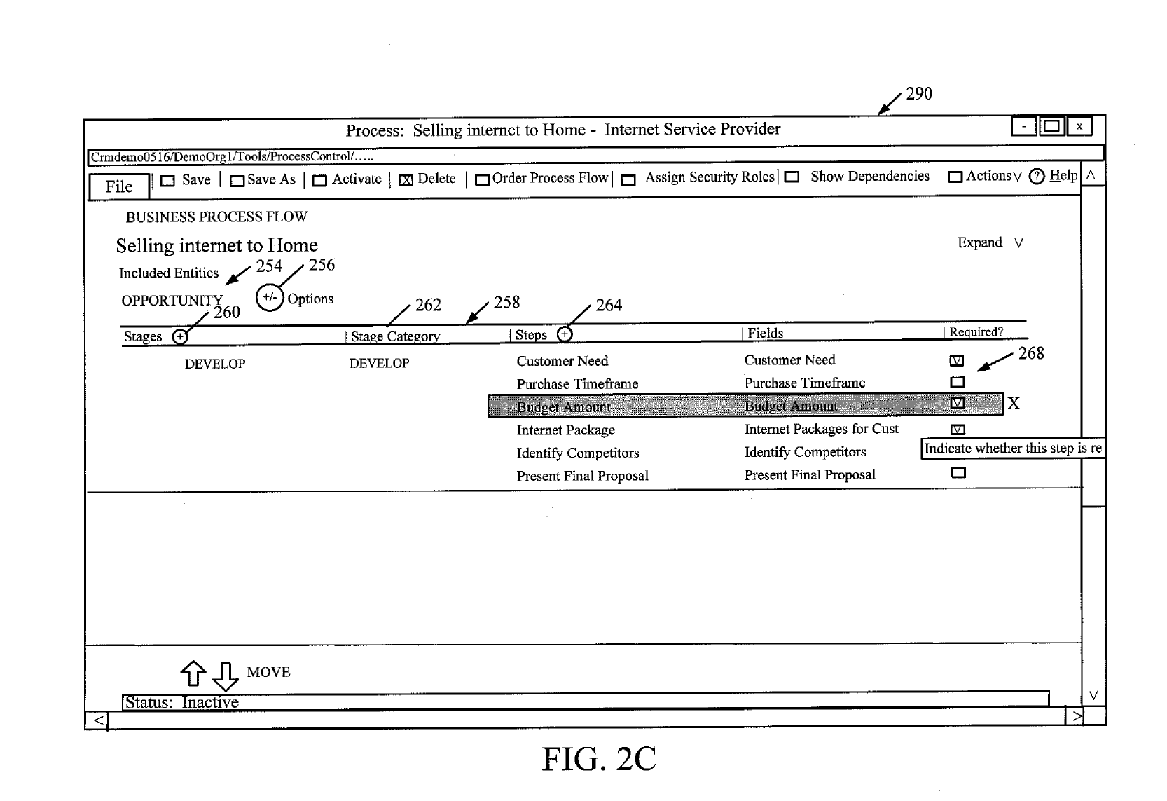

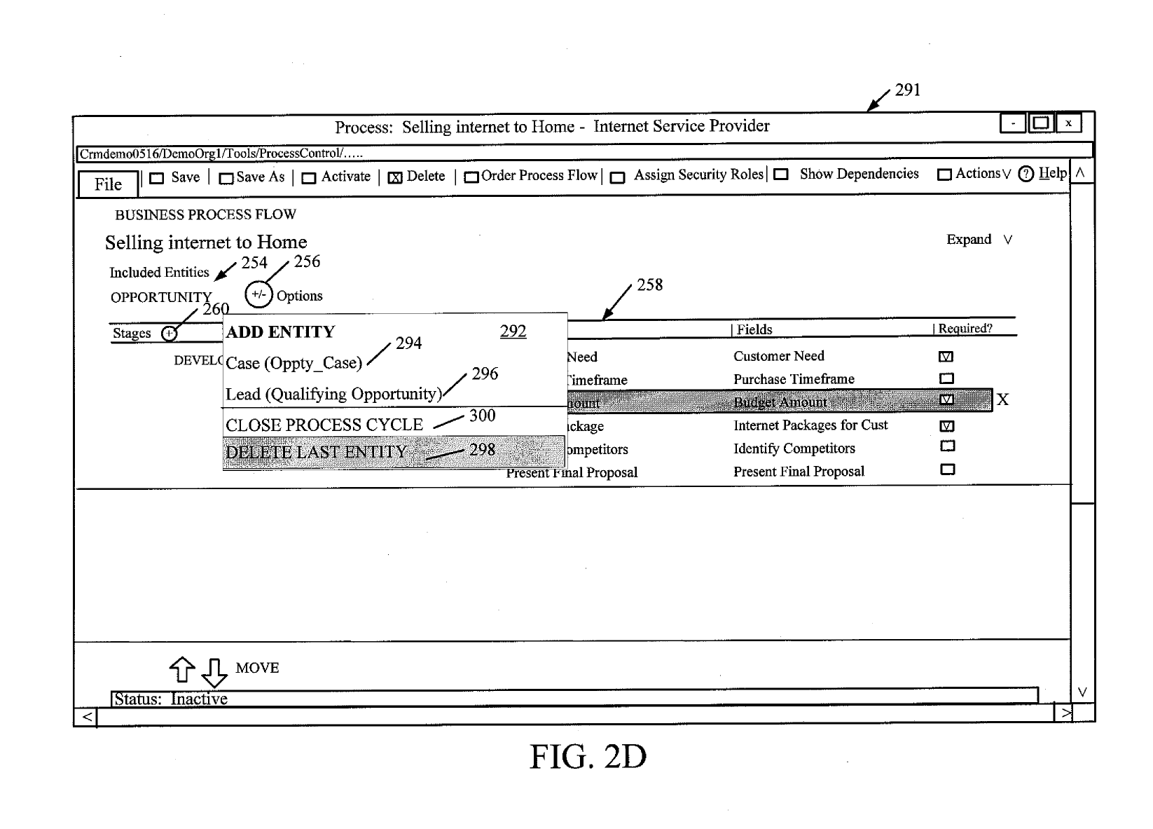

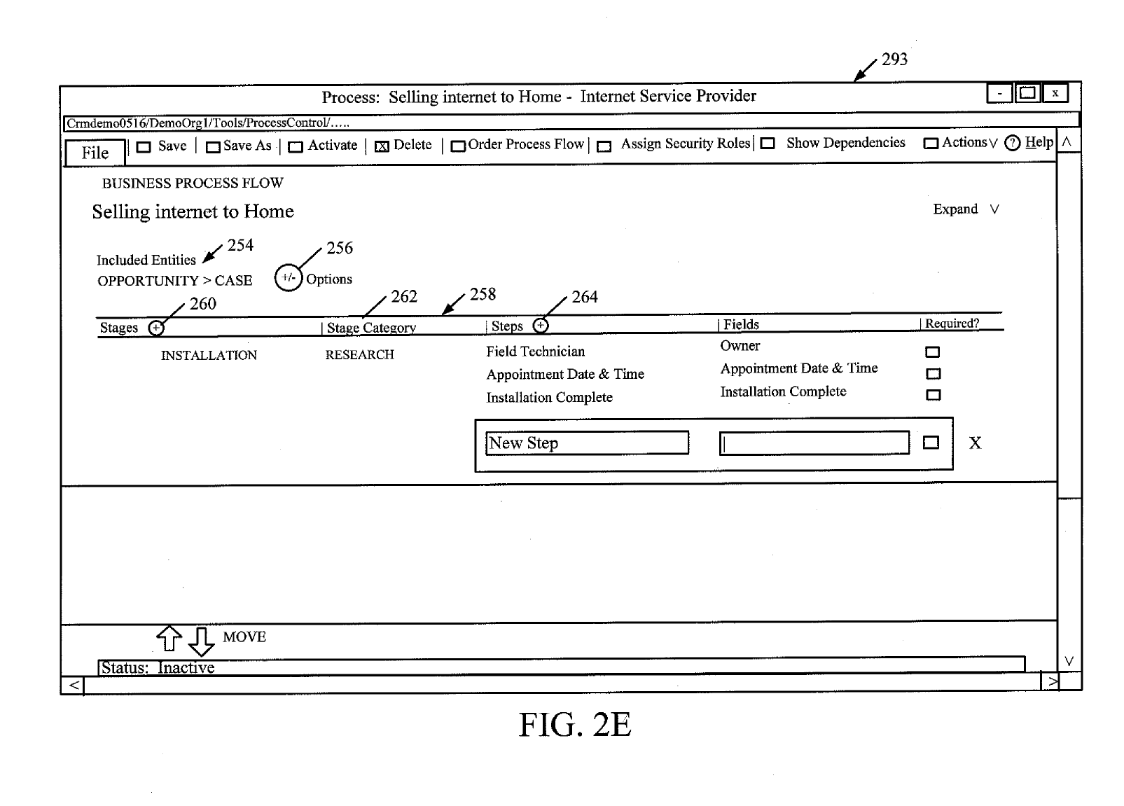

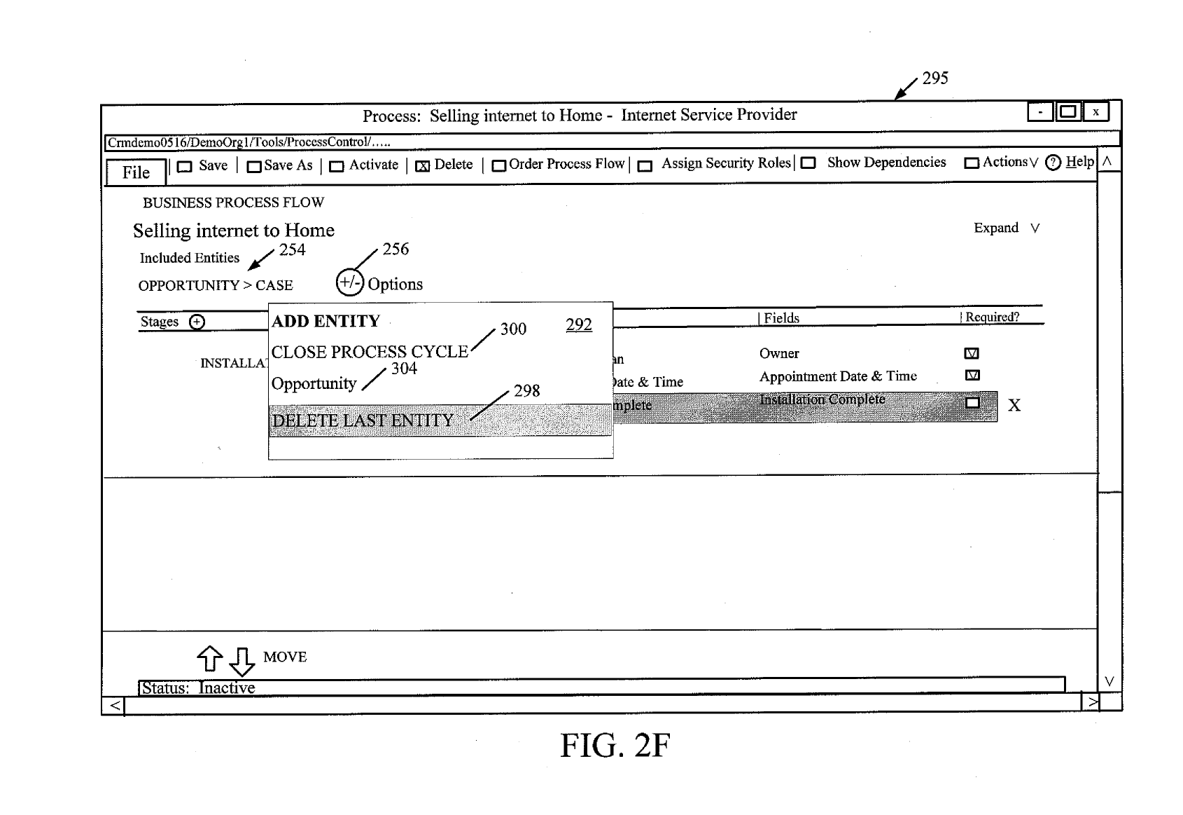

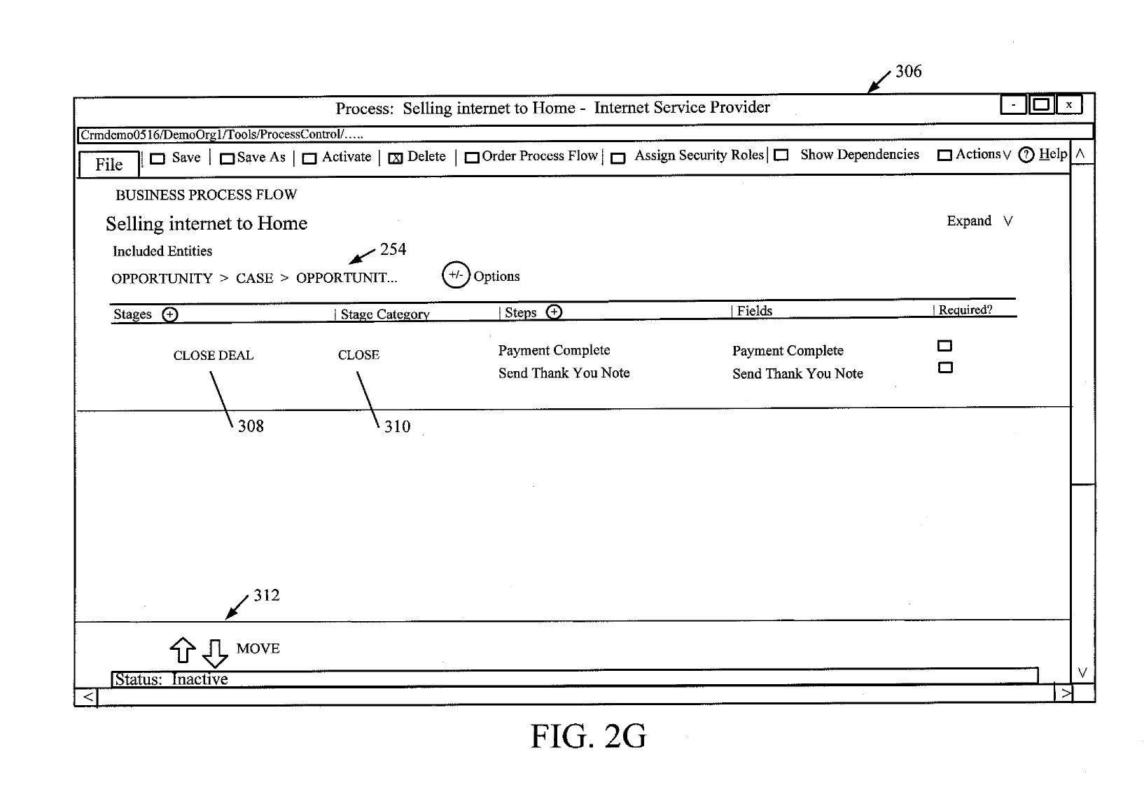

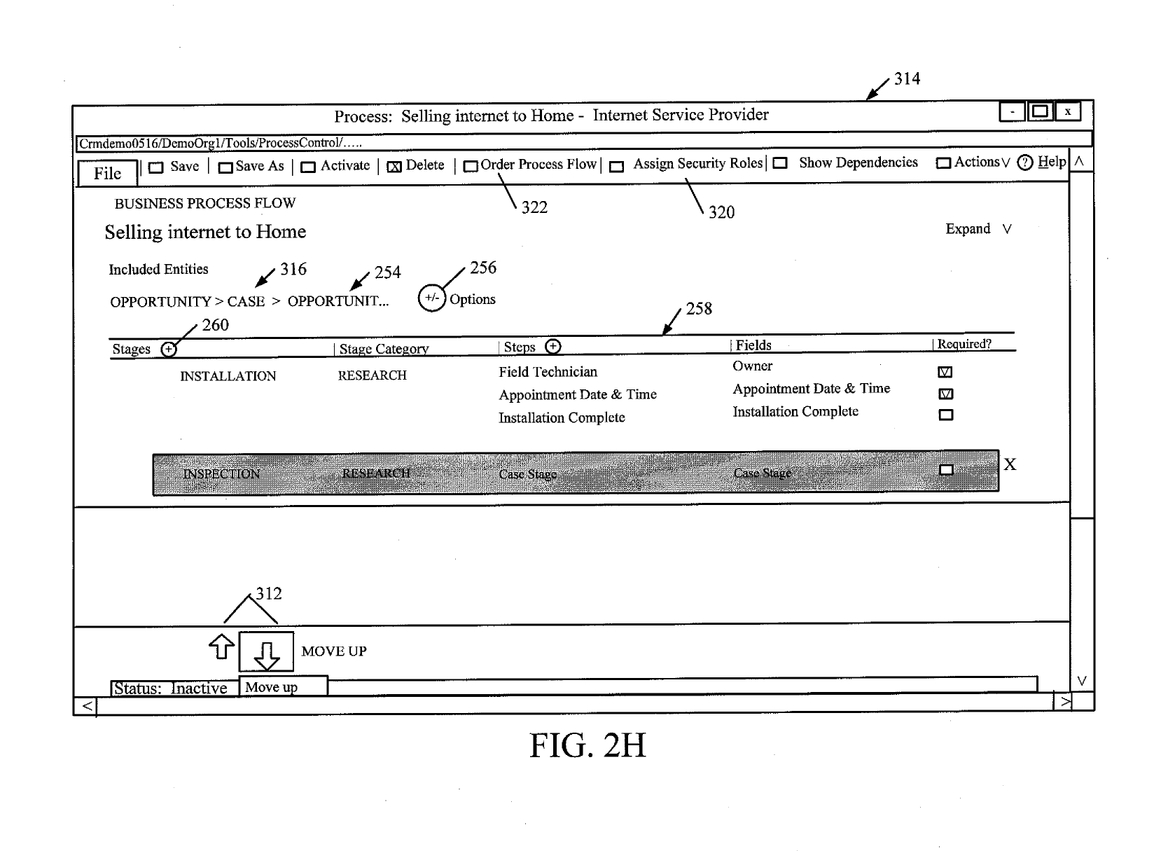

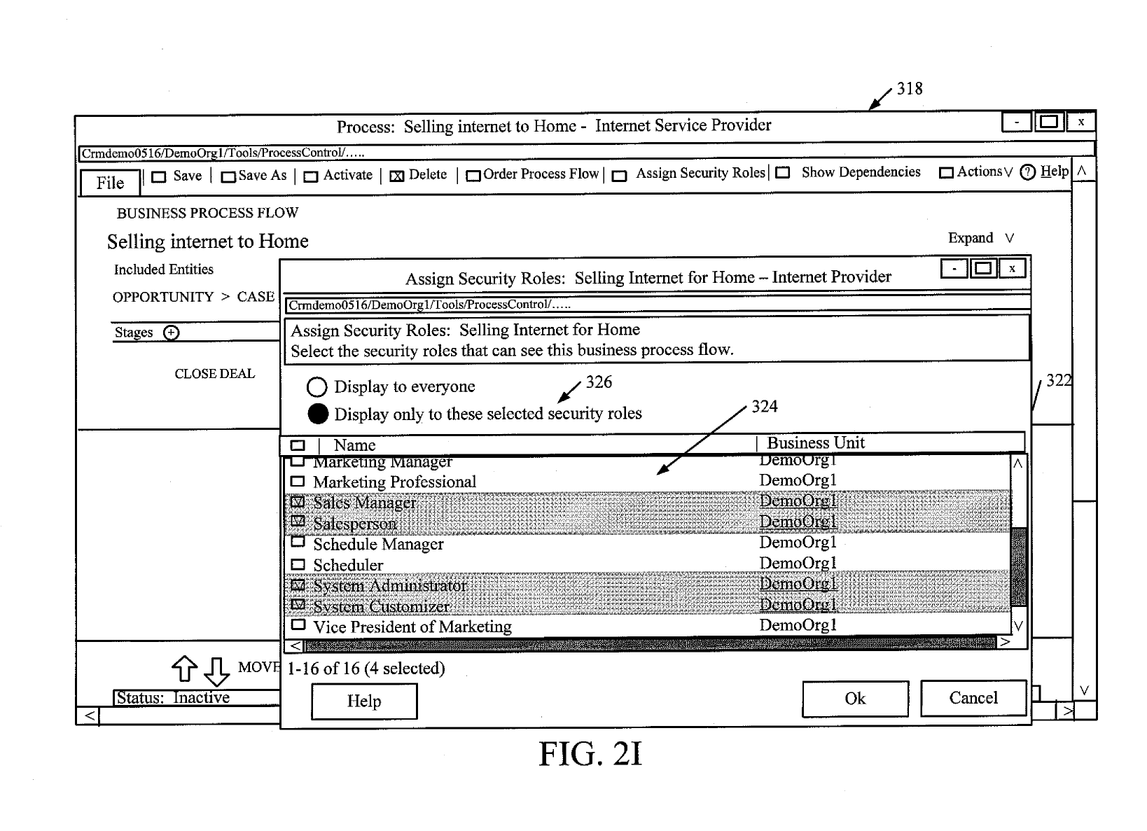

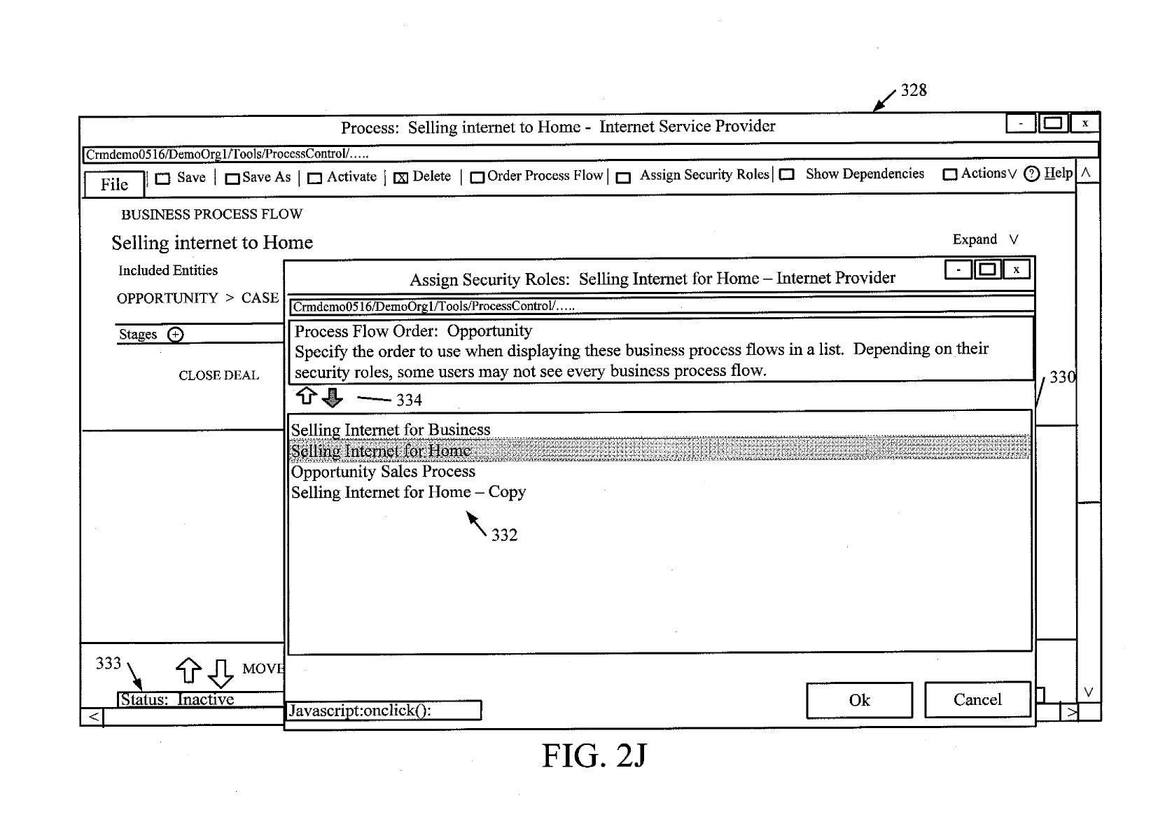

FIG. 2 is a flow diagram illustrating one embodiment of the operation of process configuration component 116 in allowing user 106 to configure a business process 122 within business system 100. FIGS. 2A-2J are illustrative user interface displays. FIGS. 1-2J will now be described in conjunction with one another.

In the following discussion, it is assumed that user 106 wishes to configure a business process 122 in business system 100 that is to be followed in order to sell internet services to a home. It is also assumed that the business process will include three stages. The first stage is to develop the deal. The second stage is installation of the services, and the third stage is to close the deal. Each stage will illustratively include a plurality of different steps, and may involve accessing more than one entity 120 in business system 100. That is, the business process may span more than one entity 120.

Process configuration component 116 first generates a user interface display to receive a user request to generate a new process. This is indicated by block 200 in FIG. 2. In one embodiment, the user can indicate a desire to define (or configure) a new process as indicated by block 202. User 106 can also illustratively indicate a desire to create the new process from an existing process template. This is indicated by block 204. The user can, of course, indicate a request to generate a new process in other ways as well, and this is indicated by block 206.

FIG. 2A is one illustrative user interface display 208 that shows how a user might do this. In the embodiment shown in FIG. 2A, user interface display 208 includes a settings pane 210. The user has selected the processes with user interface element 212 in pane 210. This causes configuration component 116 to generate an underlying user interface display 214 that lists existing processes generally at 216. User interface display 214 also illustratively includes a new processes button 218.

When the user actuates button 218, configuration component 116 illustratively generates display 220 that allows user 106 to input process identifying information for the new process. In the embodiment shown in FIG. 2A, the user can illustratively put in a process name in field 222, a process category using drop down menu 224, indicate whether the process is new or to be generated from an existing template using buttons 226 and 228, respectively, and identify an entity using drop down menu 230. Generating the user interface display to receive process identification information is indicated by block 232 in the flow diagram of FIG. 2. Allowing the user to name the process is indicated by block 234, assigning a category is indicated by block 236, assigning a process type is indicated by block 238, identifying an entity to which the process belongs is indicated by block 240, displaying other existing template information is indicated by block 242, and allowing user to put in still other process identifying information is indicated by block 244.

Process configuration component 116 then generates a set of user interface displays that allows user 106 to input business process flow definition inputs to define the process and the process flow for the new process. This is indicated by block 246 in the flow diagram of FIG. 2.

FIG. 2B shows one example of a user interface display 248 for doing this. It can be seen in FIG. 2B that display 248 includes an identifying section 250 which generally identifies the process with the identifying information input in FIG. 2A above. It also illustratively includes a description field 252 that allows a user to input a description of the process. It can be seen that the name of the process is “selling internet to home” and the description is “This is the process for selling internet to home.”

FIG. 2B also shows that user interface display 248 includes a list of entities shown generally at 254 that are included in the process. Actuator 256 allows the user to add or remove additional entities from the process. Stage defining section 258 allows the user to add or remove stages from the process and to define those stages. For instance, actuator 260 allows the user to add a stage to the process. Mechanism 262 allows the user to identify the stage category (which can be input by the user). Mechanism 264 allows the user to add steps to be followed in order to complete any given stage. Field mechanism 266 allows the user to specify fields of the entity that are affected by the steps, and required mechanism 268 allows the user to specify certain steps that are required before the user moves on to the next stage.

User interface display 248 also includes order process flow mechanism 322 and assign security roles mechanism 320. These mechanisms are described in greater detail below with respect to FIGS. 2H and 2I.

Generating a UI display to allow the user to input a description of the process is indicated by block 270 in the flow diagram of FIG. 2. Displaying the user input mechanism to allow the user to specify additional entities is indicated by block 272. Displaying a mechanism to allow the user to add additional stages is indicated by block 274. Displaying a mechanism for identifying stage categories is indicated by block 276. Displaying a mechanism for the user to add steps is indicated by block 278. Displaying a mechanism to allow the user to add fields is indicated by block 280. Displaying a mechanism so the user can identify a step as being required is indicated by block 282. Allowing the user to specify roles that have access to the process is indicated by block 284, and allowing the user to specify other information for the process is indicated by block 286.

FIG. 2B illustrates that the user has selected the “opportunity” entity. This is shown generally at 254. FIG. 2B also shows that the user has entered one stage (the “develop” stage) and has assigned that stage to the “develop” category and has shown three steps “customer need”, “purchase timeframe”, and “budget amount”. The user has also identified the “customer need” field, and the “purchase timeframe” field.

FIG. 2C shows user interface display 290, which has some of the same information as that shown in FIG. 2B, and it is similarly numbered. However, FIG. 2C also shows that the user has added three additional steps for the “develop deal” stage. Those steps are the “internet package” step, the “identify competitors” step, and the “present final proposal” step. The user has also identified fields that are to be filled out for each of those steps, and the user has also identified three of the steps as being required before the user can advance to the next stage.

FIG. 2D shows a user interface display 291 that shows that the user has actuated mechanism 256 in order to add an entity to the process. In one embodiment, possible entities to add to the process are suggested to the user in pane 292. For instance, pane 290 shown in FIG. 2D shows that the user could add the “case” entity by actuating mechanism 294, or the “lead” entity by actuating mechanism 296. Of course, the user can also delete an entity by actuating mechanism 298 or close the process cycle by actuating mechanism 300.

FIG. 2E shows a user interface display 293 that shows that the user has added the “case” entity to the process as generally indicated at 254. Thus, it can be seen that the present process will span multiple entities. FIG. 2E also shows that the user has used stage actuator 260 to add a stage corresponding to the “case” entity. In the embodiment shown in FIG. 2E, the user has added a stage 304 entitled “installation”. The user has placed the installation stage in the research category and has specified a plurality of different steps and fields corresponding to that stage, and has further indicated that at least two of those steps are required before the user can move on to the next stage.

FIG. 2F shows a user interface display 295 that shows that the user has again actuated actuator 256 to add or delete an entity with respect to the process. It can be seen that pane 292 is again generated, but this time, the suggested entity to be added is the opportunity entity indicated by actuator 304 in pane 292. Thus, the suggested entities in pane 292 for the given process can change based upon the context in which the process creation resides. Because the current entity is the “case” entity, the suggested entities in pane 292 are different than those shown in FIG. 2D, where the current entity was the “opportunity” entity.

FIG. 2G is a user interface display 306 that indicates that the user has added the opportunity entity, as again indicated generally at 254. The user has added the “close deal” stage 308 and assigned it to the “close” category 310. The user has also added a plurality of steps (“payment complete”, “send thank you note”) for the stage.

It should be noted that the stages can be reordered by the user 106 as well, by actuating the move actuators 312. FIG. 2H is a user interface display 314 that indicates this. It can be seen that the user has selected the case entity in the current process by actuating mechanism 316 corresponding to the case entity in the list of entities shown at 254. It can be seen that, at some point, the user added two stages (the installation stage and the inspection stage) to the process for the case entity. By highlighting one of the stages and actuating one of move up/move down actuators 312, the user can move the highlighted stage up or down in the list of stages. The stages will appear during the user experience performing the process in the order in which they appear in stage defining section (or pane) 258. Therefore, the user can change the order of stages corresponding to any given entity by simply moving them up or down in the list of stages in pane 258.

In one embodiment, configuration component 116 also displays a user interface display that allows the user to assign roles to a given process. By way of example, business system 100 may have roles 124 that are assigned to various users. The roles can be used to provide access, to the users, to different information in the system, and to different processes, etc. Therefore, if a role is not assigned to a process, a user having that role may not have access to that process in business system 100. Referring again to FIG. 2H, user interface display 314 illustratively includes an assign security roles mechanism (or actuator) 320 and an order process flow mechanism (or actuator) 322.

FIG. 2I shows that when the user actuates the actuator 320, configuration component 116 illustratively generates a security role assignment display 322 that allows the user to assign security roles to the process being created. It can be seen that the security roles are listed generally at 324 and each is associated with a check box. The user can check the various roles that the user wishes to have access to the newly created process. In addition, the user can indicate whether the process is to be displayed to everyone, or only to selected roles, by using actuators 326. Of course, the user can assign roles in other ways as well.

FIG. 2J shows a user interface display 328 that is illustratively generated when the user actuates the “order process flow” actuator 322, shown in FIG. 2H. Configuration component 116 illustratively generates the process flow order display 330. Display 330 illustratively includes a list of processes 332 that have already been created. It can be seen that list 332 now includes the “selling internet for home” process, the creation of which was described above. The user can specify the order to use when displaying these business processes in a list by highlighting one of the processes and using the move up/move down actuators 334. This will move the highlighted business process up or down, respectively, in the list of business processes 332. Therefore, when the business processes are displayed to a user, they will be displayed in the order shown in display 330. Of course, it will be noted that if a user has a role that does not have access to all of the business processes, then the user may not see all of the business processes in list 332 displayed to that particular user.

Once the process has been fully configured, the user changes the status of the newly created business process to active by actuating actuator 334. This is indicated by block 336 in the flow diagram of FIG. 2.

Process configuration component 116 then saves the active business process for use in business system 100, such as by placing it in business data store 112 so that it can be accessed by the various applications 114 or other components or items in business system 100. This is indicated by block 338 in FIG. 2. In this way, it can be accessed by users that have a security role that permits them to access the process.

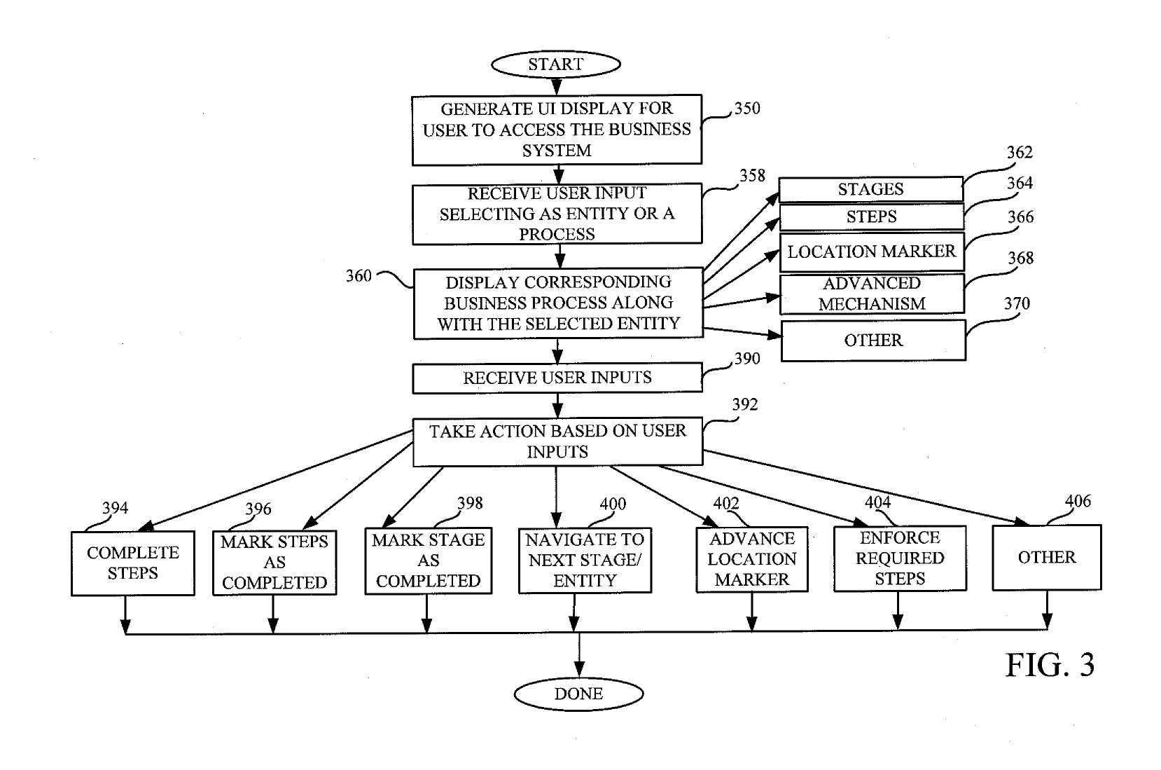

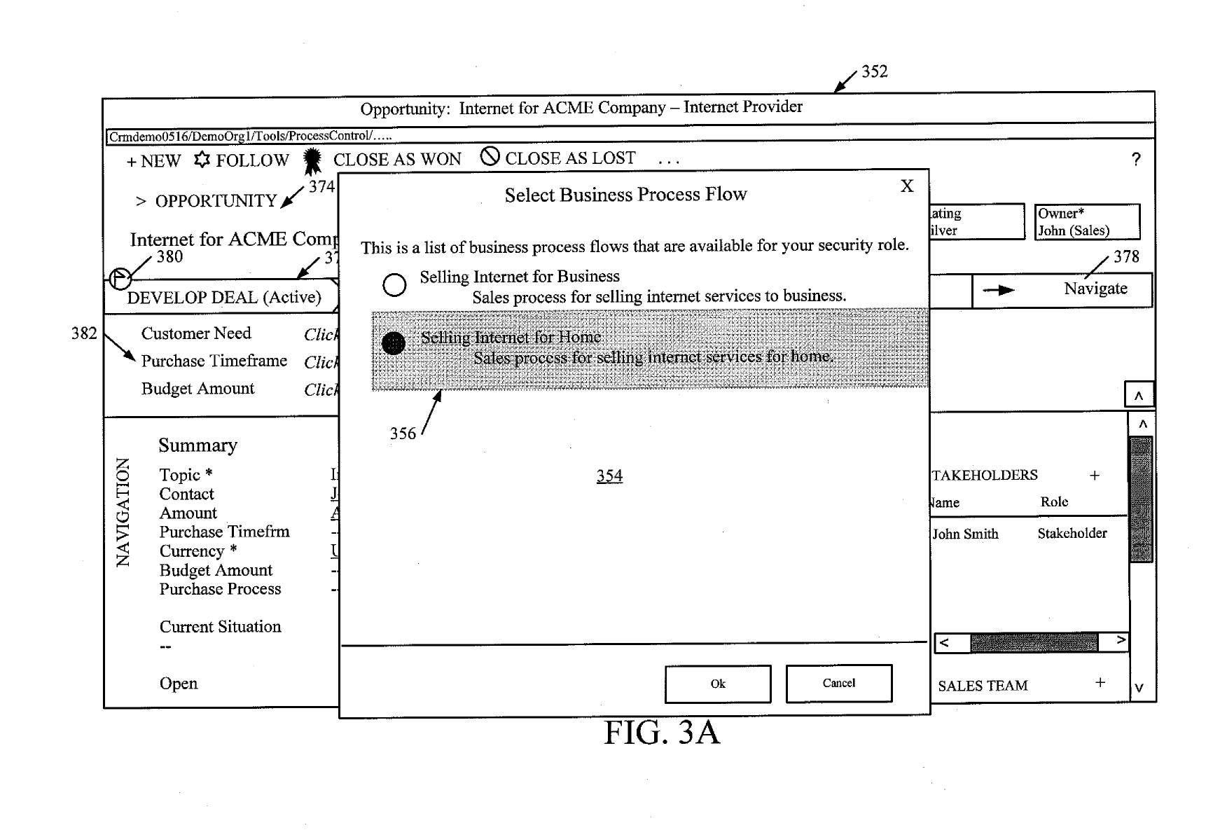

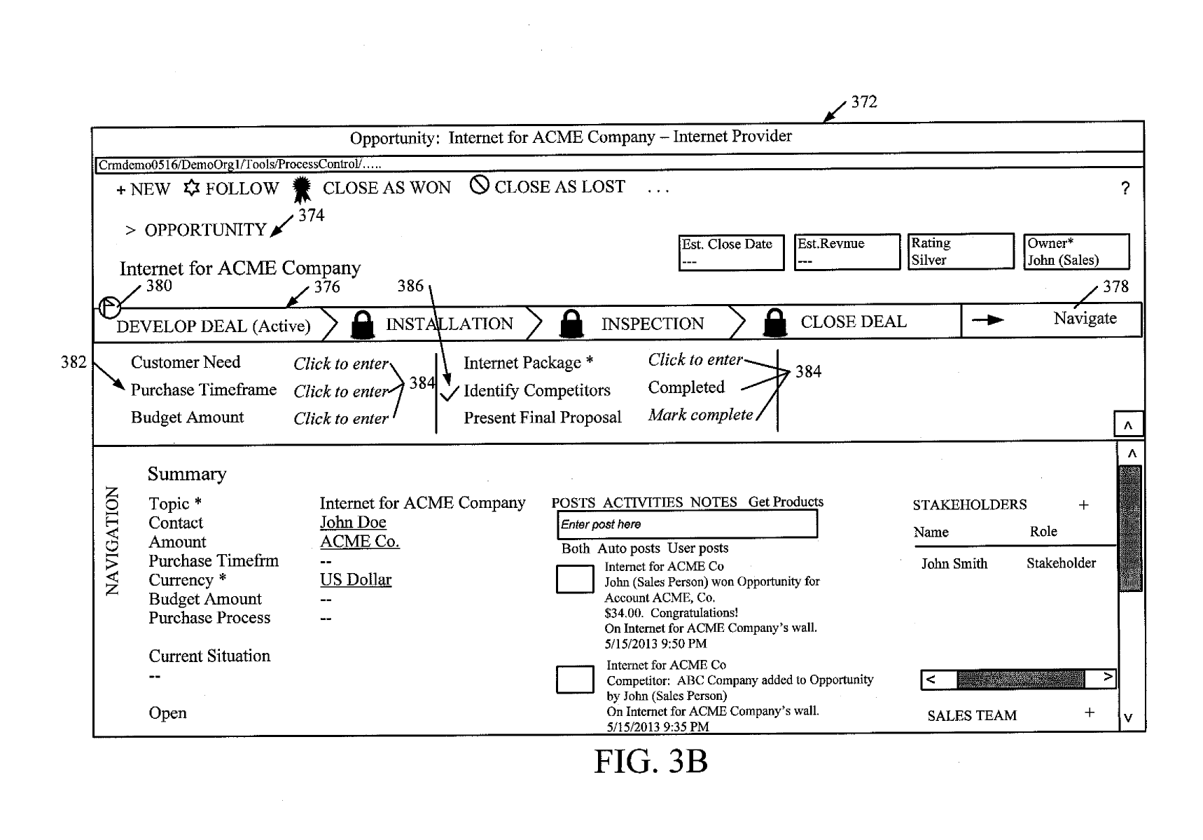

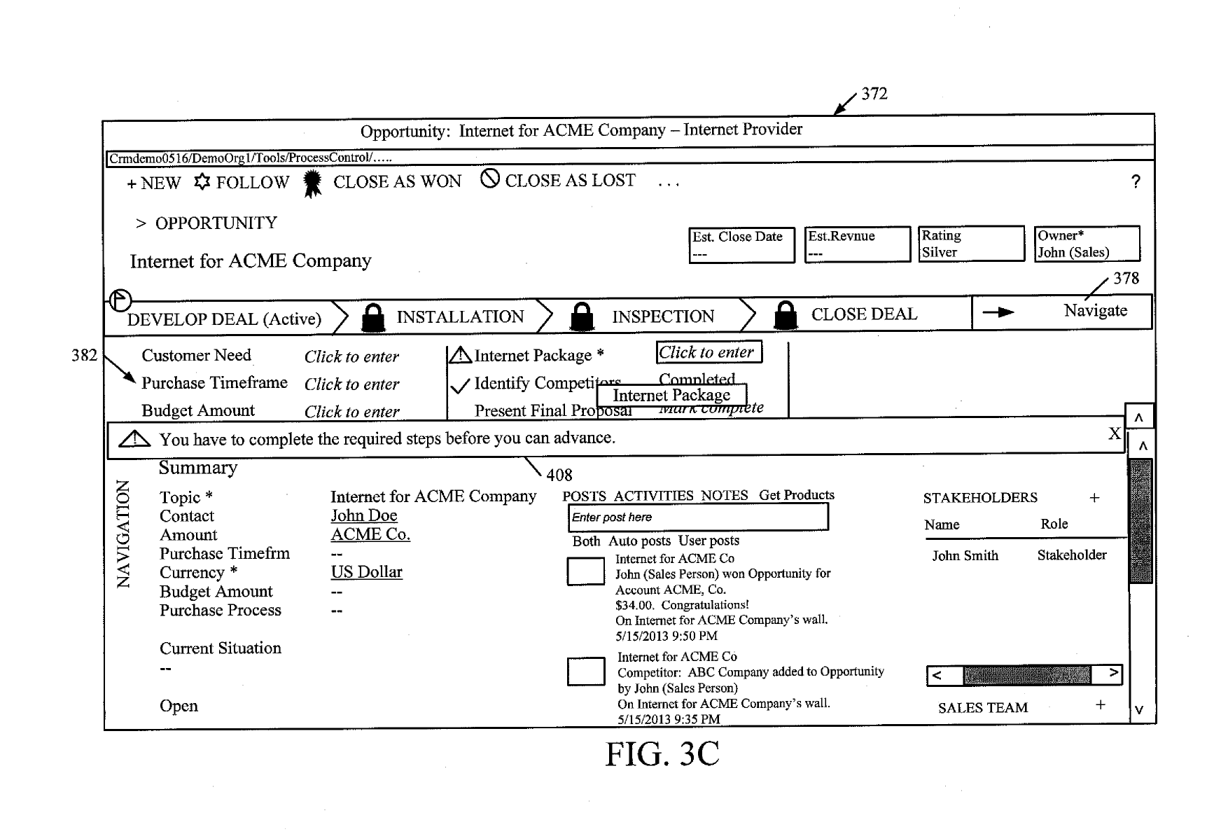

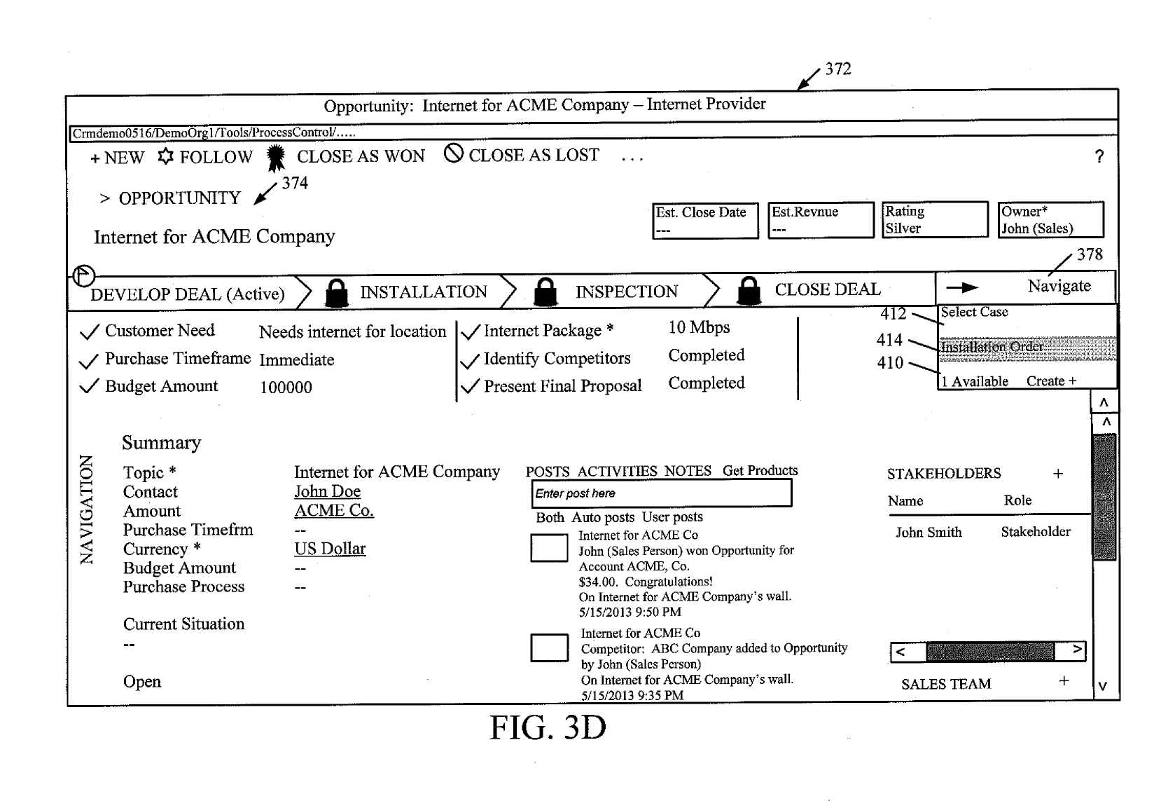

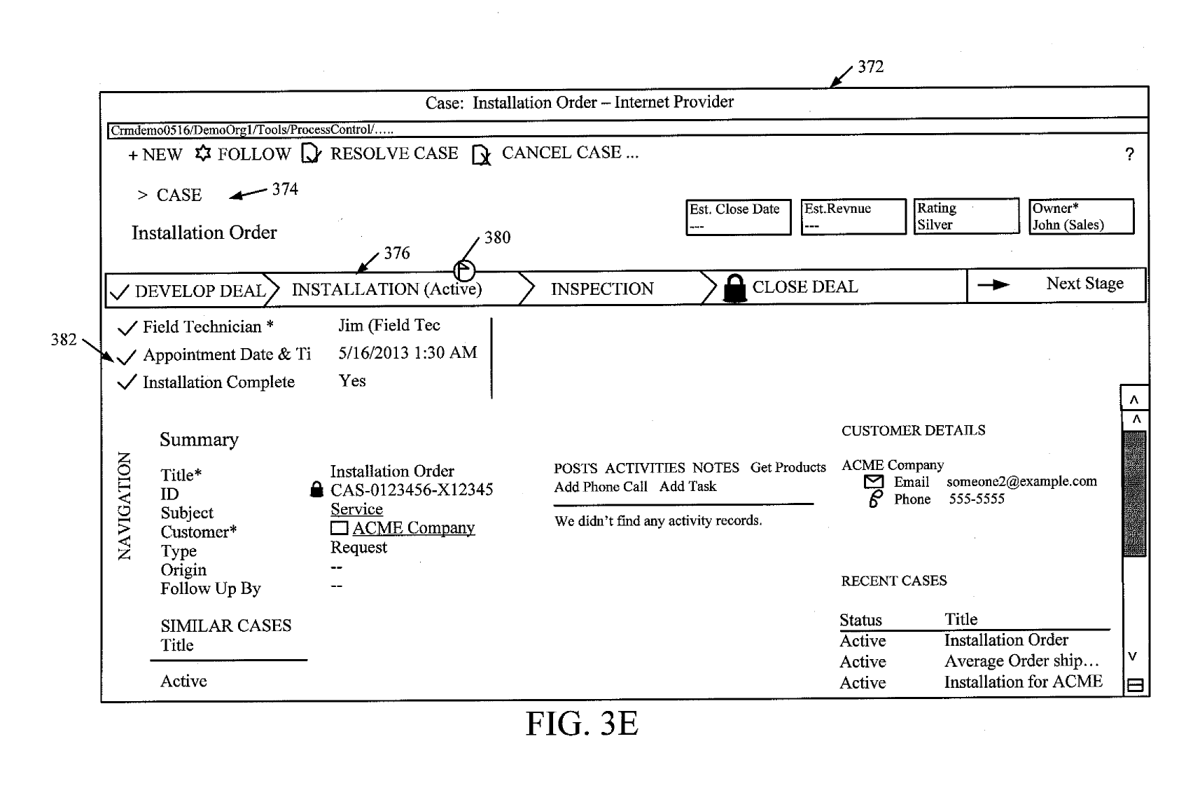

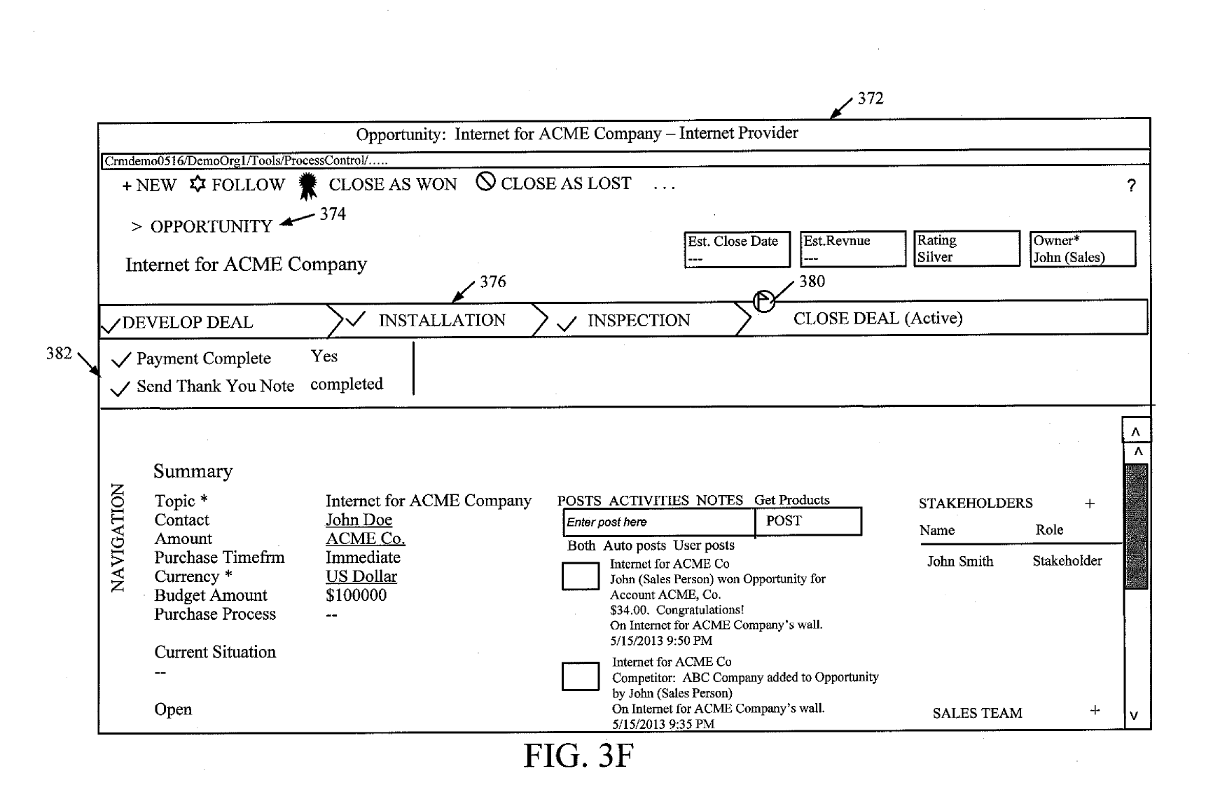

FIG. 3 is a flow diagram illustrating one embodiment of the operation of business system 100 in allowing a user to execute a process. FIGS. 3A-3F are user interface displays that illustrate this as well. FIGS. 3-3F will now be described in conjunction with one another.

Business system 100 first generates a user interface display for user 106 to access the business system. This is indicated by block 350 in FIG. 3. This can be done in a wide variety of different ways, and FIG. 3A shows a user interface display 352 that illustrates one way of doing this. FIG. 3A assumes that the user 106 has an assigned security role and that the user has accessed business system 100 (such as by providing authentication information, e.g., a user name and password), and navigated to a screen that allows the user to request to run a business process. User interface display 352 illustratively includes business process flow display pane 354 that displays all of the business processes in a list 356, that the user is authorized to see or access based on the user's role. It can also be seen in FIG. 3A that the user has selected the “selling internet for home” process, the creation of which was discussed above. Receiving the user input selecting one of the processes from list 356 is indicated by block 358 in the flow diagram of FIG. 3.

It should also be noted that the business process can be selected by the user in different ways as well. For instance, in one embodiment the user can simply select an entity and the business process or processes corresponding to that entity will be displayed for user selection. Other ways of selecting a business process can be used as well.

Business system 100 (e.g., one of applications 114) then generates a user interface display corresponding to the selected business process. This is indicated by block 360 in the flow diagram of FIG. 3. For instance, the display can show the stages 362 in the business process, the steps 364 corresponding to those stages, a location marker 366 indicating where, in the process, the user currently resides, and an advance mechanism 368 that allows the user to advance to the next step, to the next stage, etc. Of course, the display can show other information 370 as well.

FIG. 3B shows one embodiment of a user interface display 372 that illustrate this. User interface display 372 shows that the current screen corresponding to the selected process relates to the opportunity entity as generally indicated at 374. The display 372 also includes a stages display 376 that lists the various stages in the current business process, along with a navigate mechanism 378 that allows the user to navigate among the various stages shown in 376. A location indicator 380 is illustratively displayed on stages display 376 to show where, in the overall process, the user currently resides.

It can be seen from display 372 that the current business process, (which corresponds to an instance of the “selling internet for home” process) includes four stages. The stages include the “develop deal” stage, the “installation” stage, the “inspection” stage, and the “close deal” stage. All of the stages are locked except for the “develop deal” stage which is active. Below the stage display 376, display 372 includes a steps display 382. Steps display 382 illustratively lists the steps for the active stage (in this case the “develop deal” stage that are to be completed). Each step illustratively includes an actuator 384 that can be actuated by the user to complete the step. When the step is completed, an indicator (such as check mark 386) is illustratively placed next to the step indicating that it has been completed. Thus, when the user is in the “develop deal” stage, the user will actuate actuators 384 and input information to complete the steps in that stage. Receiving user inputs is indicated by block 390 in the flow diagram of FIG. 3.

Business system 100 (e.g., one of applications 114) will then take action based on the user inputs. This is indicated by block 392 in the flow diagram of FIG. 3. For instance, the user can complete the various displayed steps as indicated by block 394. The user can mark the steps as completed as indicated by block 396. The user can mark stages completed (as indicated by block 398) as the user completes all of the steps of a given stage. The user can then actuate the navigate mechanism 378 to navigate to the next stage or the next entity in this business process. This is indicated by block 400 in FIG. 3. The user can advance the location marker 380 to the next stage (or this can be done automatically when the user navigates to the next stage). This is indicated by block 402. The system 100 illustratively enforces the required steps so that the user is not able to advance to the next step until all of the required steps of a current stage are completed. Enforcing the required steps is indicated by block 404 in FIG. 3. Of course, the user can provide other inputs and system 100 can perform other actions based on those inputs. This is indicated by block 406 in FIG. 3.

FIG. 3C shows another embodiment of user interface display 372 and similar items to those shown in FIG. 3B are similarly numbered. However, it can be seen in FIG. 3C that the user has actuated the navigate actuator 378, attempting to navigate from the “develop deal” stage to the “installation” stage. However, the user had not completed all of the required steps in the “develop deal” stage. Therefore, in one embodiment, business system 100 generates a display (such as display 408) that alerts the user to the fact that all of the required steps have not been completed.

FIG. 3D shows that the user has now completed all of the steps in the “develop deal” stage and has again actuated the navigate actuator 378. This generates a display (such as drop down menu 410) that allows the user to select a new entity (such as the case entity with actuator 412) or to select a new stage (such as the installation stage using actuator 414). It can be seen that the user has selected “installation” stage from menu 410.

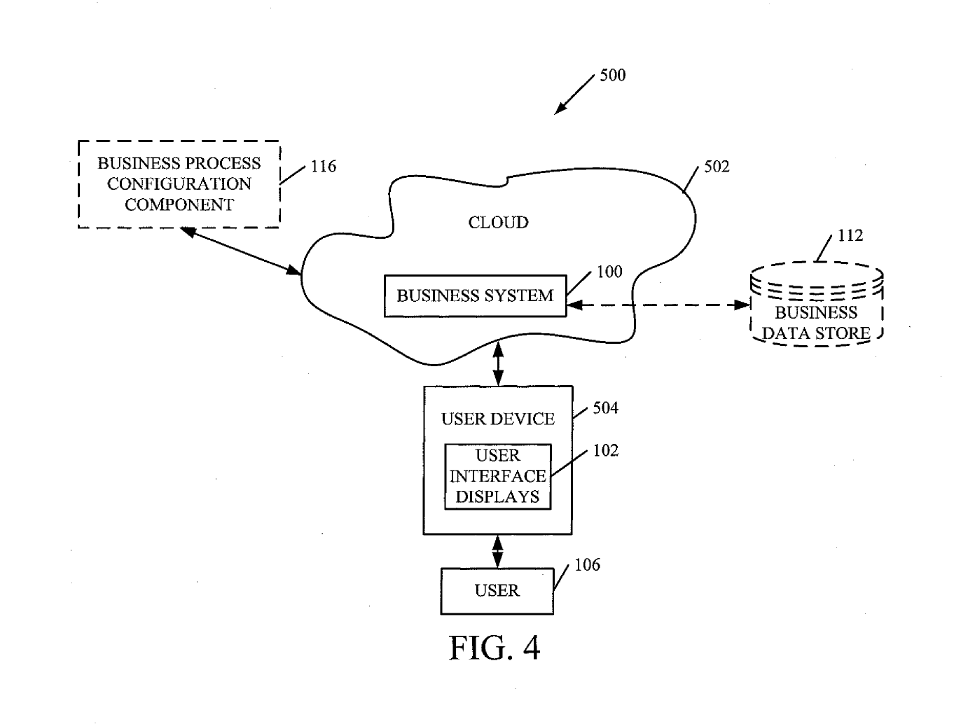

Therefore, FIG. 4E shows a user interface display 372 which is similar to those shown in FIGS. 3C and 3D, except that it can now be seen that the user has advanced to the installation stage on stage display 376. The location indicator 380 has been advanced to the installation stage and the entity display 374 has been updated to show that this final stage in the process corresponds to the “opportunity” entity. Steps display 382 has also been updated to show the steps in the “close deal” stage and to indicate that they have all been completed. Therefore, this instance of this business process can be closed.

It can thus be seen that process configuration component 116 generates user interface displays that allow a user to quickly and intuitively define a new business process that spans multiple entities. The user can also define multiple business processes that correspond to a single entity. Business system 100 also generates a user experience when the process is performed that shows the user where he or she resides in the business process, at each given stage. The user interface displays also show all of the stages in the process, and the steps corresponding to each stage, and indicates which steps are to be performed before advancing to the next stage. This can make the development and execution of business processes much more intuitive and easier to follow.

FIG. 4 is a block diagram of business system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of business system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that system 100 is located in cloud 502 (which can be public, private, or a combination where portions are public while others are private). Therefore, user 106 uses a user device 504 to access those systems through cloud 502.

FIG. 4 also depicts another embodiment of a cloud architecture. FIG. 4 shows that it is also contemplated that some elements of system 100 are disposed in cloud 502 while others are not. By way of example, data store 112 (which can be part of system 100) can be disposed outside of cloud 502, and accessed through cloud 502. In another embodiment, business process configuration component 116 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

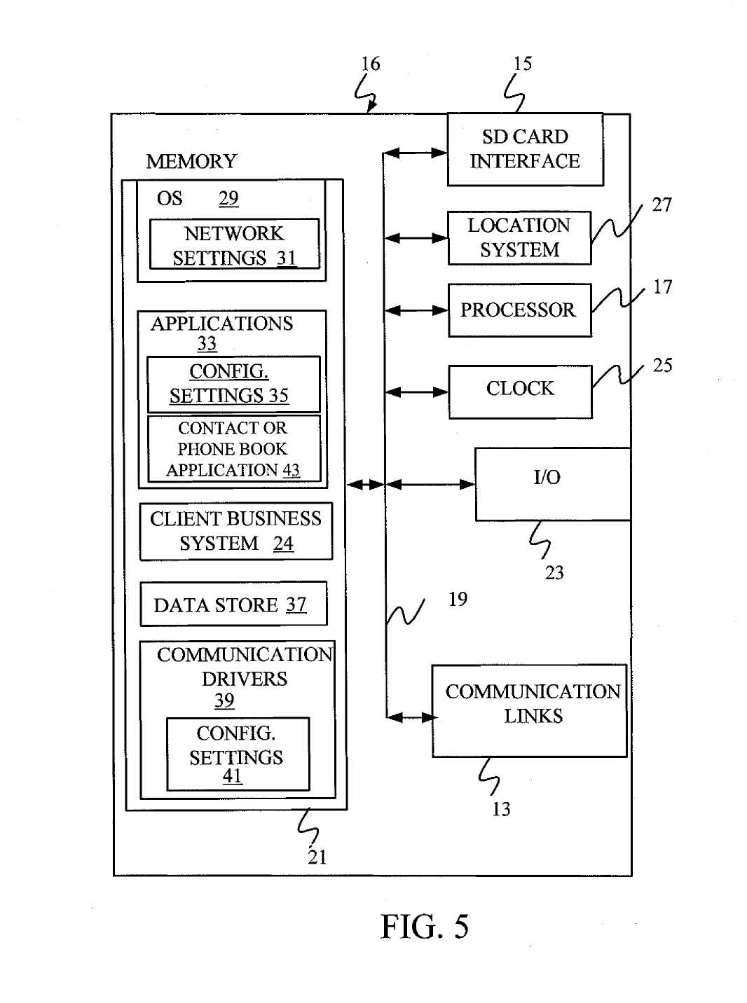

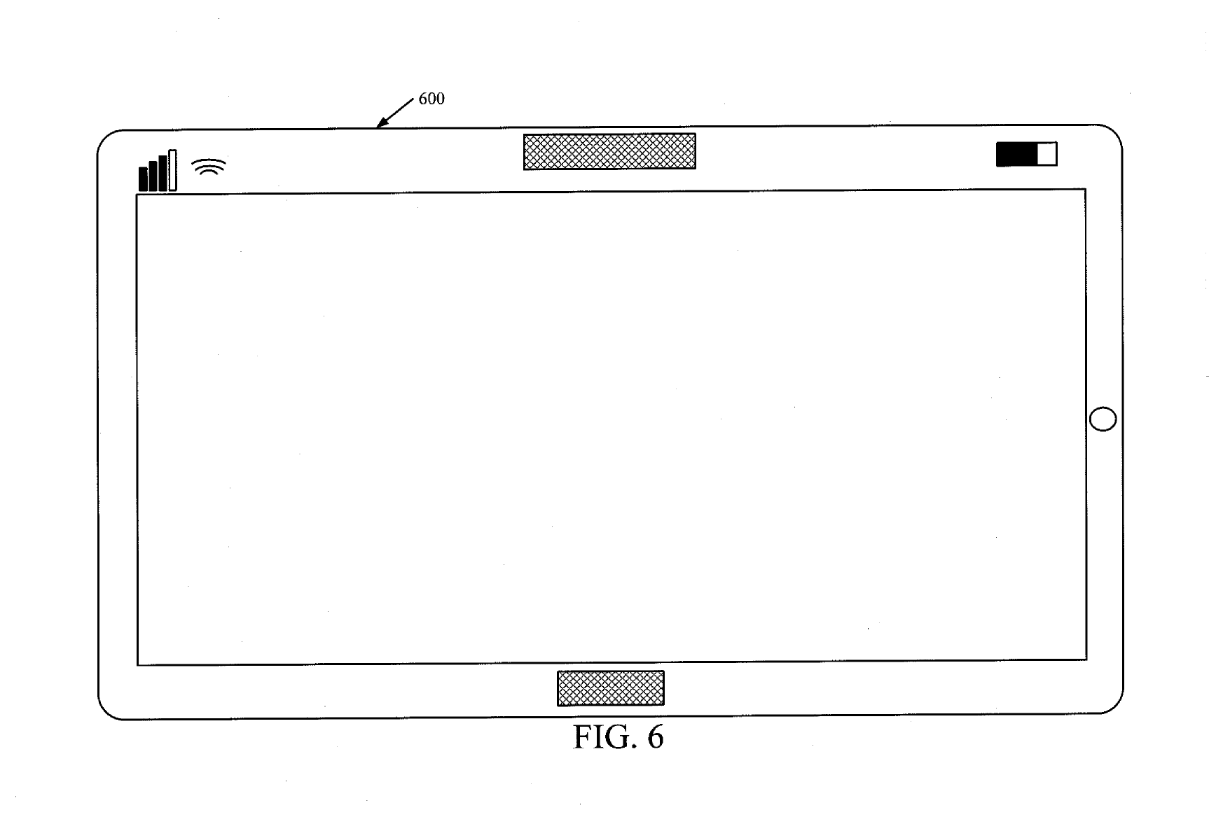

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of system 100 or system 100 or that interacts with system 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3 G and 4 G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 108 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of business system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

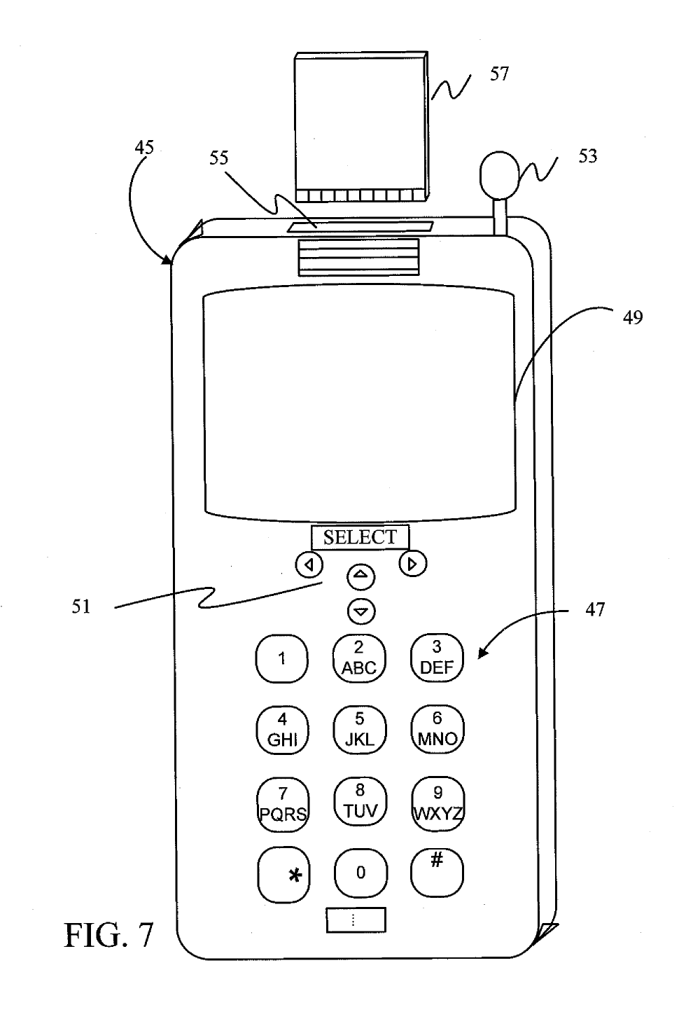

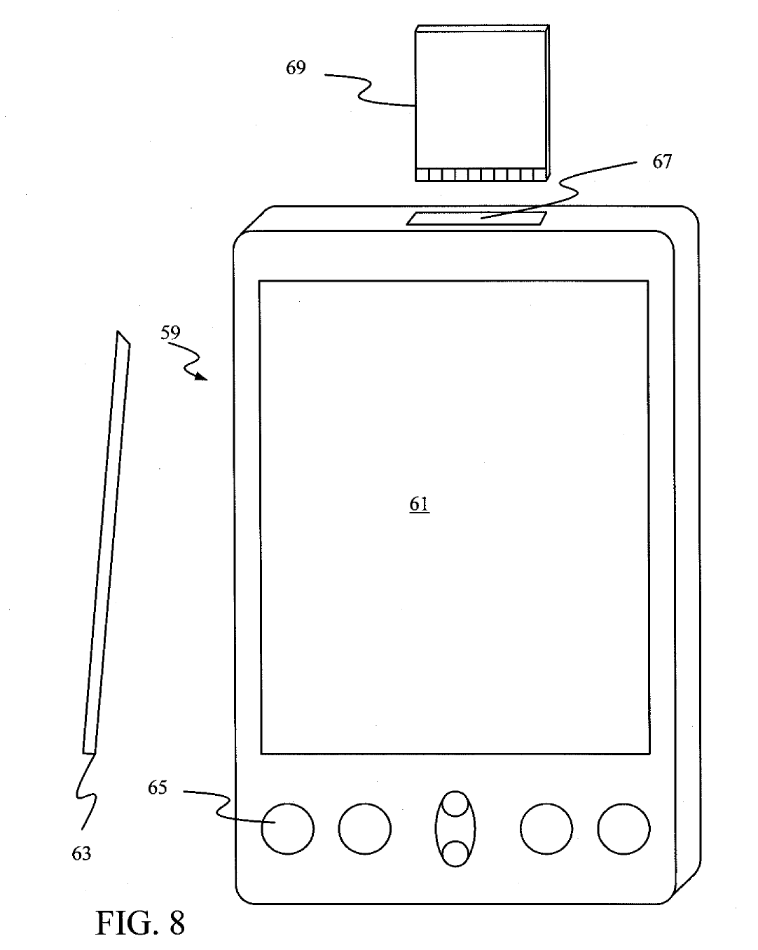

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

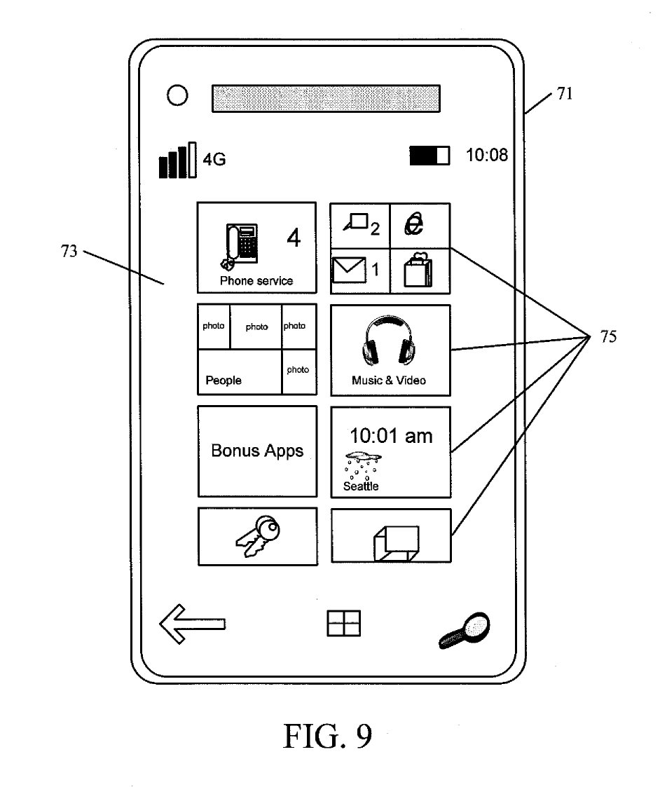

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

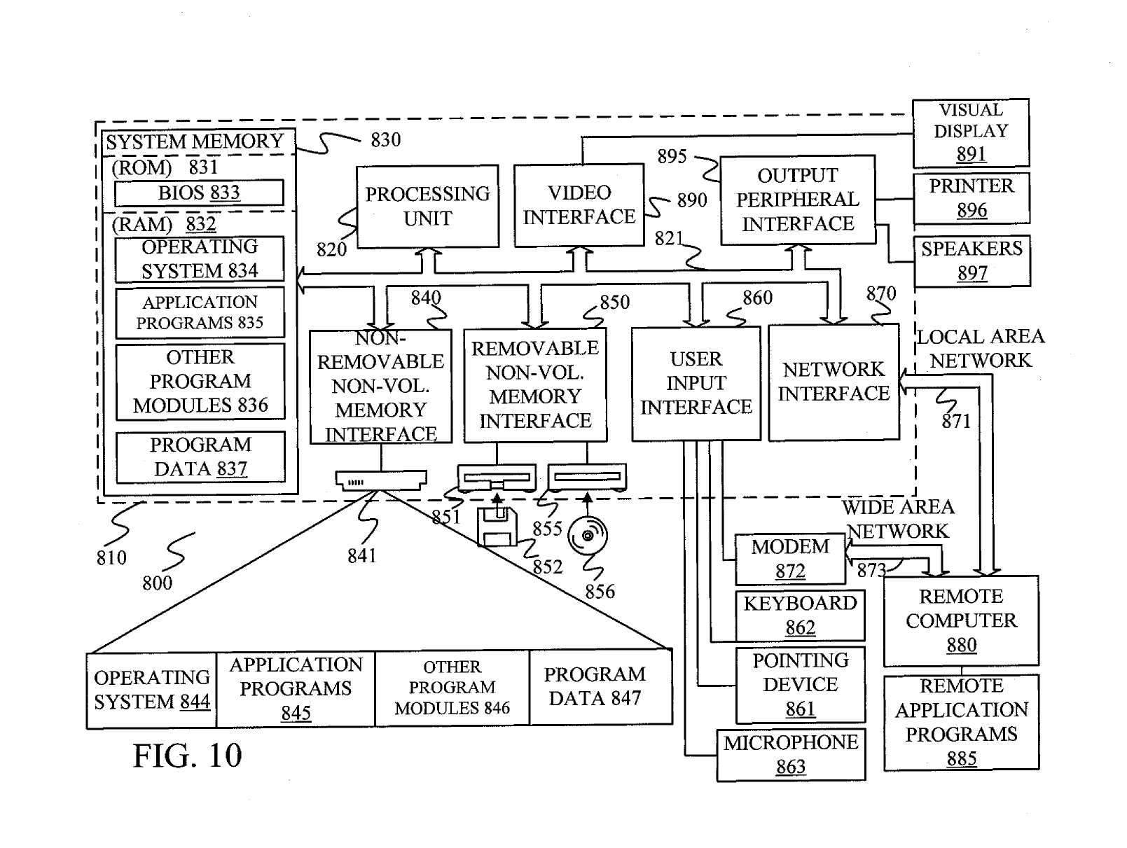

FIG. 10 is one embodiment of a computing environment in which system 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 108), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of configuring a process in a computer system, comprising:
displaying a process identifying user interface display with identifying user input mechanisms that receive process identifying user inputs that identify a process to be configured, the identifying user input mechanisms including an entity identifier input mechanism that receives an entity identification user input identifying a first entity corresponding to the process;
displaying a process flow definition user interface display with process flow user input mechanisms that receive process flow user inputs that define a flow for the process, corresponding to the first entity; and
after receiving the process identifying user inputs and the process flow user inputs, storing the process for access by users of the computer system.

2. The computer-implemented method of 1 wherein the computer system comprises a business system, the process comprises a business process in the computer system and the first entity comprises a first business entity and wherein displaying the process flow user input mechanisms comprises:
displaying a stages user input mechanism that receives a stages user input identifying stages of the business process.

3. The computer-implemented method of claim 2 wherein displaying the process flow user input mechanisms comprises:
displaying a steps user input mechanism receiving a steps user input identifying steps to be completed at each stage of the business process.

4. The computer-implemented method of claim 3 wherein displaying the process flow user input mechanisms comprises:
displaying a required user input mechanism receiving a required user input identifying selected steps as being required before advancing to a subsequent stage in the business process.

5. The computer-implemented method of claim 4 wherein displaying the process flow user input mechanisms comprises:
displaying a fields user input mechanism receiving a fields user input identifying fields of the first entity affected by each step in each stage.

6. The computer-implemented method of claim 5 wherein displaying the process flow user input mechanisms comprises:
displaying an entity selector user input mechanism on the process flow definition user interface display; and
receiving entity selection user inputs that identify subsequent entities that correspond to subsequent stages in the business process, so the business process spans a plurality of different entities.

7. The computer-implemented method of claim 6 wherein displaying the process flow user input mechanisms comprises:
displaying a role assignment user input mechanism that receives a role assignment user input indicative of roles in the business system that have access to the business process.

8. The computer-implemented method of claim 7 wherein displaying the process flow user input mechanisms comprises:
displaying a stage category user input mechanism that receives a stage category user input assigning a stage category to each stage in the business process.

9. A computer-implemented method of performing a process in a computer system, comprising:
displaying a process user interface display, for a selected process, that includes a stages display showing an ordered set of stages that are to be performed, in order, to perform the selected process, and a steps display showing steps to be completed for a selected stage, along with steps user input mechanisms that receive steps user inputs to complete the steps;
displaying an entity display on the process user interface display that identifies an entity corresponding to the selected stage; and
displaying a location indicator, indicative of a location on the stages display that the selected process is in.

10. The computer-implemented method of claim 9 wherein the computer system comprises a business system, wherein the process comprises a business process within the business system and wherein the entity comprises a business entity in the business system

11. The computer-implemented method of claim 10 wherein displaying a process user interface display comprises:
displaying an advance user input mechanism that receives an advance user input to advance to a subsequent stage from the selected stage; and
in response to the advance user input, determining whether all required steps for the selected stage have been completed.

12. The computer-implemented method of claim 11 and further comprising:
if all of the required steps for the selected stage have not been completed, displaying an indication that the process cannot advance to the subsequent stage until all the required steps have been completed.

13. The computer-implemented method of claim 12 and further comprising:
if all the required steps for the selected stage have been completed, marking the selected stage as being complete on the stages display; and
advancing the location indicator to the subsequent stage on the stages display.

14. The computer-implemented method of claim 13 and further comprising:
displaying a steps display showing steps to be completed for the subsequent stage, along with steps user input mechanisms that receive steps user inputs to complete the steps for the subsequent stage.

15. The computer-implemented method of claim 14 and further comprising:
if the subsequent stage corresponds to a different entity, then updating the entity display to show the different entity.

16. The computer-implemented method of claim 10 and further comprising:
displaying a process selection user interface display with process selection user input mechanisms that receive a selection user input selecting the selected process for performance.

17. The computer-implemented method of claim 16 wherein displaying the process selection user interface comprises:
identifying a user role; and
displaying process selection user inputs for only processes to which the user role has been granted access.

18. A computer readable storage medium storing computer executable instructions which, when executed by a computer, cause the computer to perform steps, comprising:
displaying a process identifying user interface display with identifying user input mechanisms that receive process identifying user inputs that identify a process to be configured, the identifying user input mechanisms including an entity identifier input mechanism that receives an entity identification user input identifying a first entity corresponding to the process;
displaying a process flow definition user interface display with process flow user input mechanisms that receive process flow user inputs that define a flow for the process, corresponding to the first entity, including an ordered set of stages for the first entity; and
after receiving the process identifying user inputs and the process flow user inputs, storing the process for access by users of the computer system.

19. The computer readable storage medium of claim 18 wherein the process comprises a business process in a business system and further comprising:
displaying a process selection user input mechanism; and
receiving a process selection user input, through the process selection user input mechanism, selecting the process for execution.

20. The computer readable storage medium of claim 19 and further comprising:
displaying a process user interface display, for the selected process, that includes a stages display showing an ordered set of stages that are to be performed, in order, to perform the selected process, and a steps display showing steps to be completed for a selected stage, along with steps user input mechanisms that receive steps user inputs to complete the steps;
displaying an entity display on the process user interface display that identifies an entity corresponding to the selected stage; and
displaying a location indicator, indicative of a location on the stages display that the selected process is in.
